(19) United States
(12) Patent Application Publication
(10) Pub. No.: US 2016/0342175 A1
(43) Pub. Date: Nov. 24, 2016

(54) SMART JEWELRY

(71) Applicants: Michal Zachariás, Palkovice (CZ); Marcela Simková, Horne Srnie (SK); Adam Herout, Brno (CZ); István Szentandrási, Tesedikovo (SK); Stanislav Gálik, Brno (CZ)

(72) Inventors: Michal Zachariás, Palkovice (CZ); Marcela Simková, Horne Srnie (SK); Adam Herout, Brno (CZ); István Szentandrási, Tesedikovo (SK); Stanislav Gálik, Brno (CZ)

(21) Appl. No.: 14/716,749

(22) Filed: May 19, 2015

(51) Int. Cl. G06F 1/16; A44C 15/00; A44C 1/00; A44C 5/00

(52) U.S. Cl. CPC G06F 1/163; A44C 5/0007; A44C 15/005; A44C 1/00

(57) ABSTRACT

A smart jewelry comprising a core comprising a first electronic component and a power source; and a face comprising a recess adapted to accept the core and a second electronic component, embodying a method for initiating smart jewelry functionality, comprising inserting a core into a recess in a face to establish a communication coupling between a first electronic component of the core and a second electronic component of the face; and initiating smart jewelry functionality in accordance with information exchanged between the first electronic component and the second electronic component is disclosed.

### BACKGROUND

1. Field

The present disclosure relates to wearable technology. More particularly, this invention is directed toward wearable technology in a form of smart jewelry.

2. Description of Related Technology

Current technology enabled appearance of wearable technology, i.e., articles like clothing and/or accessories incorporating computer and/or advanced electronic technologies. The designs may incorporate the computer and/or the advanced electronic technologies into practical articles, e.g., watches, headgear with displays for soldiers, devices monitoring physiological functions of a body, but may also have a purely aesthetic agenda, e.g., clothes and jewelry. Such articles are often referred to by a modifier “smart”, i.e., smart watches, smart jewelry, and the like.

Existing articles thus comprise the computer and/or the advanced electronic technology, collectively an electronic component, implementing designed feature(s) embedded into the wearable, e.g., clothing, watch, headgear, and other wearables known to a person of ordinary skill in the art. Feature(s) of the wearables are in general uniquely designed for a particular wearable. By means of an example, Universal Serial Bus (USB) heating gloves keep hands warm when the USB is plugged into a power supply, the electronic technology in a headgear may display an overlay image, virtual information like an electronic map or an arrow showing the correct way to a destination, and the like.

In addition to the unique features, the electronic component may also support generic features, i.e., features relating to the whole class of the wearables, e.g., communication with another device, usually, but not exclusively, over a wireless link.

Such a design approach may not be best suited for smart jewelry, wherein a user may own several pieces of jewelry of different types, i.e., bracelets, necklaces, brooches, and the like, each piece with a unique and/or a different set of features. Consequently, it may not be economically feasible to design the electronic component with a unique and/or a different set of features for each piece.

Accordingly, there is a need in the art for a design of smart jewelry, providing a solution to the above identified problems, as well as additional advantages.

### SUMMARY

In an aspect of the disclosure, smart jewelry according to appended independent claims is disclosed. Additional aspects are disclosed in the dependent claims.

### BRIEF DESCRIPTION OF THE DRAWINGS

The foregoing aspects described herein will become more readily apparent by reference to the following description when taken in conjunction with the accompanying drawings wherein:

FIG. 1 depicts a conceptual structure of smart jewelry 100 in accordance with an aspect of this disclosure;

FIG. 2 depicts a conceptual structure 200 of an interface between a core and a face in accordance with an aspect of this disclosure;

FIG. 3 depicts a conceptual flow chart 300 of a process for initiating smart jewelry functionality in accordance with aspects of this disclosure;

FIG. 4a depicts a first part of a flow chart 400 of the process for initiating smart jewelry functionality of FIG. 3 in accordance with aspects of this disclosure; and

FIG. 4b depicts a second part of the flow chart 400 of the process for initiating smart jewelry functionality of FIG. 3 in accordance with aspects of this disclosure.

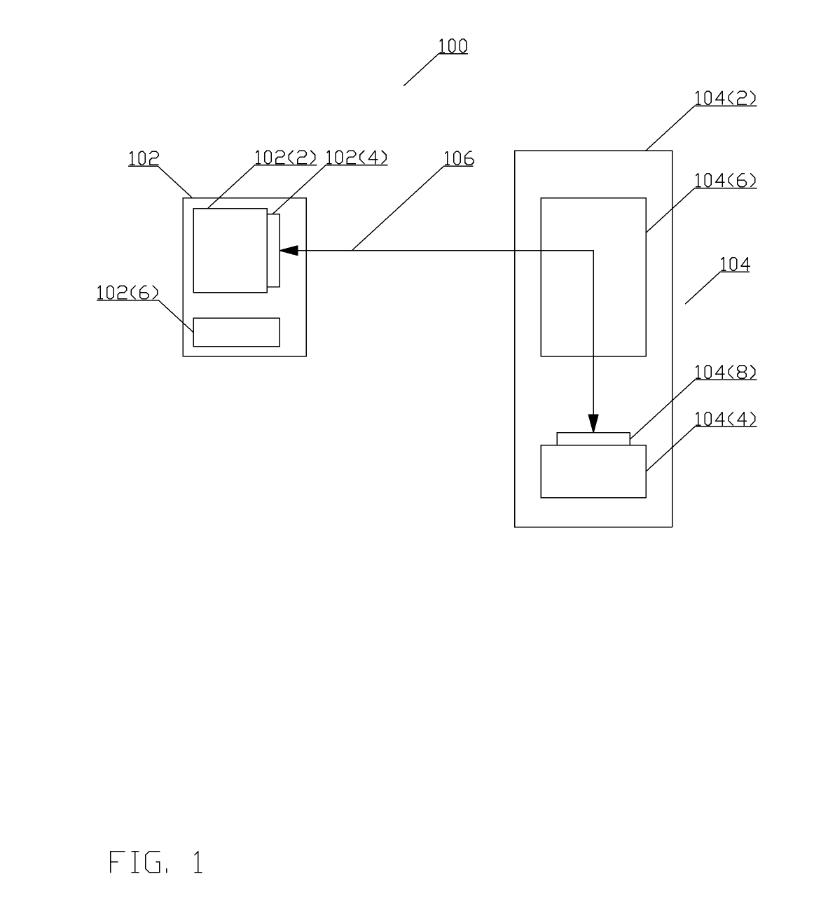

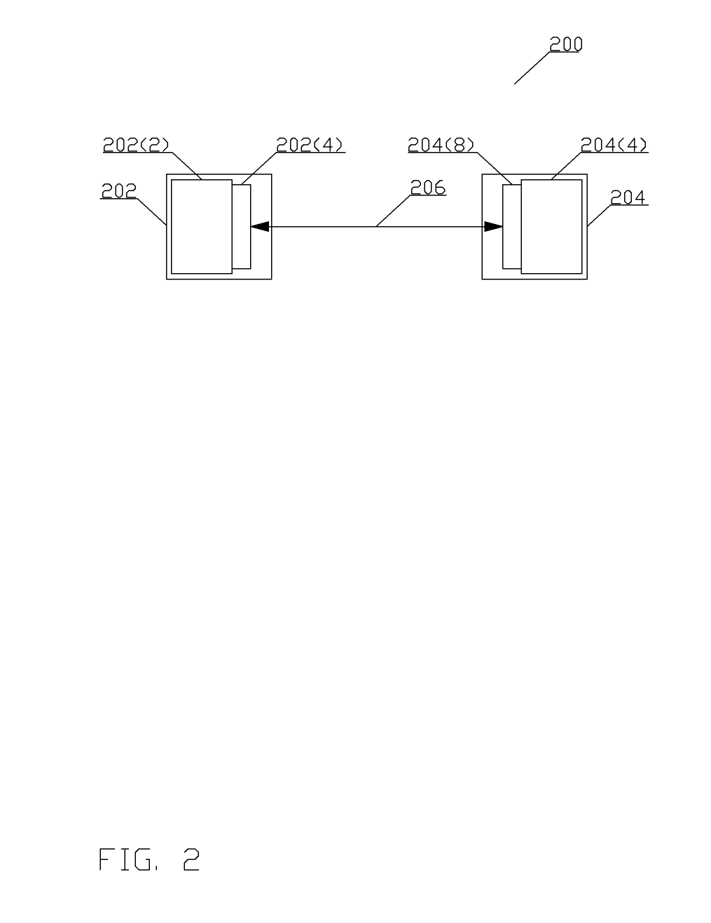

The description of like structural elements among the figures, is not repeated, the like elements have reference numerals differing by an integer multiple of 100, i.e., reference numeral 102 in FIG. 1, becomes reference numeral 202 in FIG. 2; unless differences and/or alternative aspects are explicitly noted. A reference “X(Y)” indicates a sub-block Y of a block X in a drawing where helpful for better understanding. Any unreferenced single and/or double-arrow line indicates a possible information flow between the depicted entities.

### DETAILED DESCRIPTION

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a”, “an”, and the are intended to include the plural forms as well, unless the context clearly indicates otherwise. It will be further understood that the terms “comprise”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

The term “communicatively coupled” is intended to specify a communication path permitting information exchange either directly among the communicatively coupled entities, or via an intervening entity.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

Various aspects of the present invention will be described herein with reference to drawings that are schematic illustrations of conceptual configurations of the present invention, unless explicitly noted. The various aspects of this disclosure are provided to enable a person having ordinary skill in the art to practice the present invention. Modifications to various aspects presented throughout this disclosure will be readily apparent to a person having ordinary skill in the art, and the concepts disclosed herein may be extended to other applications.

FIG. 1 depicts a conceptual structure of a smart jewelry 100 in accordance with an aspect of this disclosure. The structure 100 comprises at least a core 102 and a face 104 compatible with each other. The core 102 comprises a first electronic component 102(2) implementing generic features comprising, e.g., establishing communication between the core 102 and a host device (not shown), sensing condition of a power source, user notification about events from the host device, acquisition of functions specific to the face 104, acquisition of feedback from the user via the face 104, emergency functions invocation, and other generic features known to a person of ordinary skill in the art. The notification about events from the host device, e.g., incoming text messages, e-mails, calls, and/or other events that originate in the host applications, may comprise, e.g., vibration, change in color, temperature, or other properties of the face 104, display, electronic paper, or other means of notification known to a person of ordinary skill in the art. The acquisition of feedback from the user may comprise, e.g., acquisition of data for gestures recognition, such as tap, double tap, multi tap, shake, and the like, acquisition of input via buttons, microphone, touch controls, e.g., touch-pad, track-pad, and/or acquisition of other feedback known to a person of ordinary skill in the art. The host device comprises any electronic device, which connects with the smart jewelry described here, and offers resources, services, and applications as disclosed herein. The host device may comprise, e.g., a mobile phone, a tablet computer, a personal digital assistant, smart appliance, and/or other devices capable of communication with the core 102 known to a person of ordinary skill in the art. The communication may be carried over any communication media, e.g., wired or wireless, and protocols e.g., Bluetooth, Wi-Fi, which both the master device and the core 102 are capable of.

The face 104 comprises a decorative item 104(2) worn by the user for personal adornment, e.g., a brooch, a ring, a necklace, earrings, a bracelet, a second electronic component 104(4), and a recess 104(6) adapted to accept the core 102. In one aspect, the face 104 may be a plain face, wherein the second electronic component 104(4) implements circuitry storing the face 104 identifier and enabling additional functionality of the core 102 as described infra. In another aspect, the face 104 may be a smart face, wherein the second electronic component 104(4) implements circuitry storing the face 104 identifier and implementing features unique to a specific smart face 104. Unique features may comprise, e.g., monitoring and optionally displaying environmental or user information, e.g., temperature of the environment, user heartbeat, and the like, implementing user-controllable functions, e.g., display backlight, color, blinking pattern, speaker, timer, step counter, and the like, and other specific functions known to a person of ordinary skill in the art.

A person of ordinary skill in the art will understand that whether a feature is generic, and, therefore, implemented on the core 102 or unique and, therefore, implemented on the smart face 104 depends on design criteria. By means of an example, if many of the different pieces of smart faces 104 are intended to comprise a display, the display's supporting circuitry may be included in the core 102. If, on the other hand, only few pieces of smart faces 104 are intended to comprise a display, the display's supporting circuitry may be implemented in the second electronic component 104(4) of the smart faces 104 comprising display.

By separating the functionality of the core 102 from that of the second electronic component 104(4) of the smart face 104 several deficiencies of the art are addressed. On the designer's side, the resources associated with the development for features of the core 102, as well as the cost of the core itself may be optimized, because the features specific to a smart face 104 are implemented on the second electronic component 104(4) of a specific smart face 104. On the user's side, the user may purchase only a single core 102, which will be compatible with different smart faces 104. Thus, a significant change in generic feature, e.g., change of wireless communication protocol, is implemented on a single common component—the core 102. Additional advantages or improvements will be understood by a person of ordinary skills in the art from the following description.

To achieve the compatibility between the core 102 and the different pieces of face 104, the recess 104(6) comprises standardized dimensions, i.e., dimensions that a recess for all the different pieces of the face 104 adheres to. Therefore, the core 102, dimensions of which are also standardized to be accepted by the recess 104(6), may be exchanged between the different faces 104. When the core 102 is inserted into the recess 104(6) of the face 104, the core 102 is communicatively coupled with the second electronic component 104(4) via an interface 106, i.e., a shared boundary across which two separate components of a system exchange information. The communicative coupling is conceptually depicted as a connection between a first port 102(4) on the first electronic component 102(2), a second port 104(8) on the second electronic component 104(4). The term port comprises a logical point exposing an interface. The port may comprise a connector, i.e., a mechanical device associated with a port for connecting two or more ports. For simplicity, the connectors are not shown.

A person of ordinary skill in the art will understand that although the different elements of the face 104 are depicted as separate entities disposed at different positions within the face 104, this is for explanation of the inventive concepts only. Thus, in another aspect (not shown), the second electronic component 104(4), the connector associated with the second port 104(8), or both may be disposed within the recess 104(6).

The first electronic component 102(2) and the second electronic component 104(4) are energized by a power source, e.g., a battery, a super-capacitor, or another source of power, e.g., a solar panel, an energy harvesting technology, i.e., technology deriving power from e.g., movement of the power source, or a combination thereof. In one aspect (shown), the power source 102(6) may be comprised in the core 102 only, thus providing power to the first electronic component 102(2) and to the second electronic component 104(4) via the interface 106 when the core 102 is communicatively coupled with the smart face 104. Accordingly, the user needs to assure that power source in only one component, i.e., the core 102 is charged. In another aspect (not shown), the core 102 and the smart face 104 each have a separate power sources.

The power source 102(6) may be charged via the interface 106 either from an external charger (not shown) comprising an interface mechanically and electrically compatible with the core's 102 interface, or from the face 104, should the face comprise a power source in a form of e.g., a battery, a super-capacitor, or other source of power in a form of e.g., a solar panel, an energy harvesting technology, as disclosed supra. Should the face 104 comprise its own power source, e.g., a battery, a super-capacitor, the power source may be, likewise charged via a source of power, e.g., a solar panel, an energy harvesting technology.

FIG. 2 depicts a conceptual structure 200 of the interface 206 between the core 202 and the face 204 in accordance with an aspect of this disclosure. The interface 206 comprises a first port 202(4) and a second port 204(8). The first port 202(4) and the second port 204(8) are communicatively coupled when the core 202 is inserted into the recess in the face (not shown). In one aspect, the interface ports 202(4) and/or 204(8) comprise electronic circuitry separate from the first electronic component 202(2) and/or the second electronic component 204(4) respective. In another aspect, the interface ports 202(4) and/or 204(8) comprise electronic circuitry implemented as a portion of the first electronic component 202(2) and/or the second electronic component 204(4) respective.

The number of connective lines on the connectors (not shown), associated with the interface ports 202(4) and/or 204(8) respectively depends on implementation of the interface 206 and power source(s) for the core 202 and the face 204. However, regardless of the implementation, the interface 206 must comprise at least a bidirectional line for data transfer, and a reference line for the bidirectional data line. The power for the face 104 may then be derived from the data signal, e.g., by a rectifier, rectifying the data signal, and charging a source of power, e.g., a capacitor, a super capacitor, or a battery. The source of power then provides power to the face 204. Communication protocol for the data transfer is designed to enable charging the source of power. By means of an example, the communication protocol may initially provide data with positive potential in respect to the reference line. By means of another example, the communication protocol may initially provide data with high duty cycle of the positive potential in respect to the reference line.

In another aspect, the interface comprises three electrical lines—bidirectional data, unidirectional or bidirectional power, power reference, e.g., ground. In yet another aspect, a higher number of lines can be used, e.g., by separating directions of energy/data transfer, or by increasing the number of lines used for parallel data transfer.

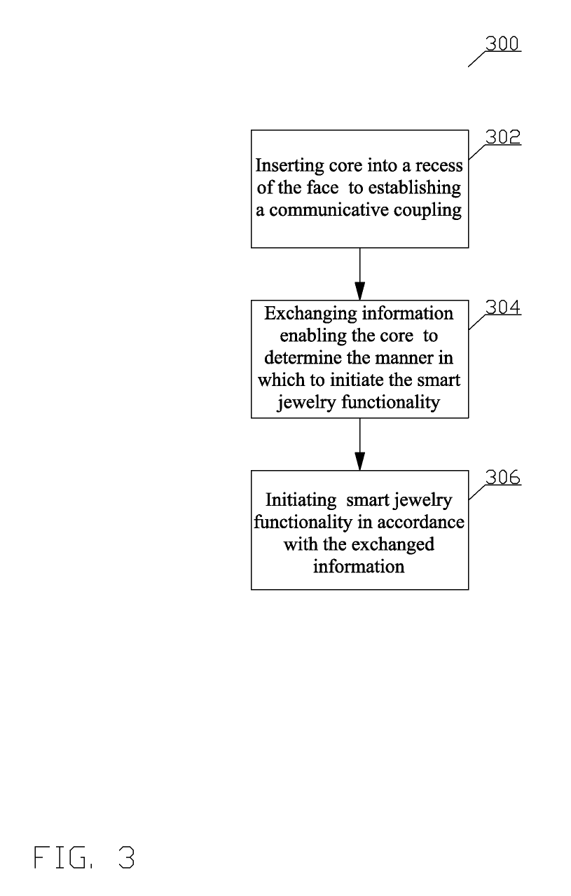

FIG. 3 depicts a conceptual flow chart 300 of a process for initiating smart jewelry functionality in accordance with aspects of this disclosure. To further clarify the relationship between certain elements of a conceptual structure and information flow among the elements of the structure, in the FIG. 3 description, the references to structural elements of FIG. 1 are in parenthesis. Furthermore, it is assumed that regardless of the power source(s) arrangement, both the first electronic component 102(2) of the core 102 and the second electronic component 104(4) of the smart face 104 are receiving power either before, or upon inserting the core 102) into the recess 104(6) of the face 104.

In block 302, the core (102) is inserted into the recess (104(6)) of the face (104), thus establishing a communicative coupling of the first electronic component (102(2)) with the second electronic component (104(4)) via the interface (106). The process continues in block 304.

In block 304, the core (102) and the face (104) exchange information enabling the core (102) to determine the manner in which to initiate the smart jewelry functionality. The process continues in block 306.

In block 306, the core (102) initiates smart jewelry functionality in accordance with the exchanged information.

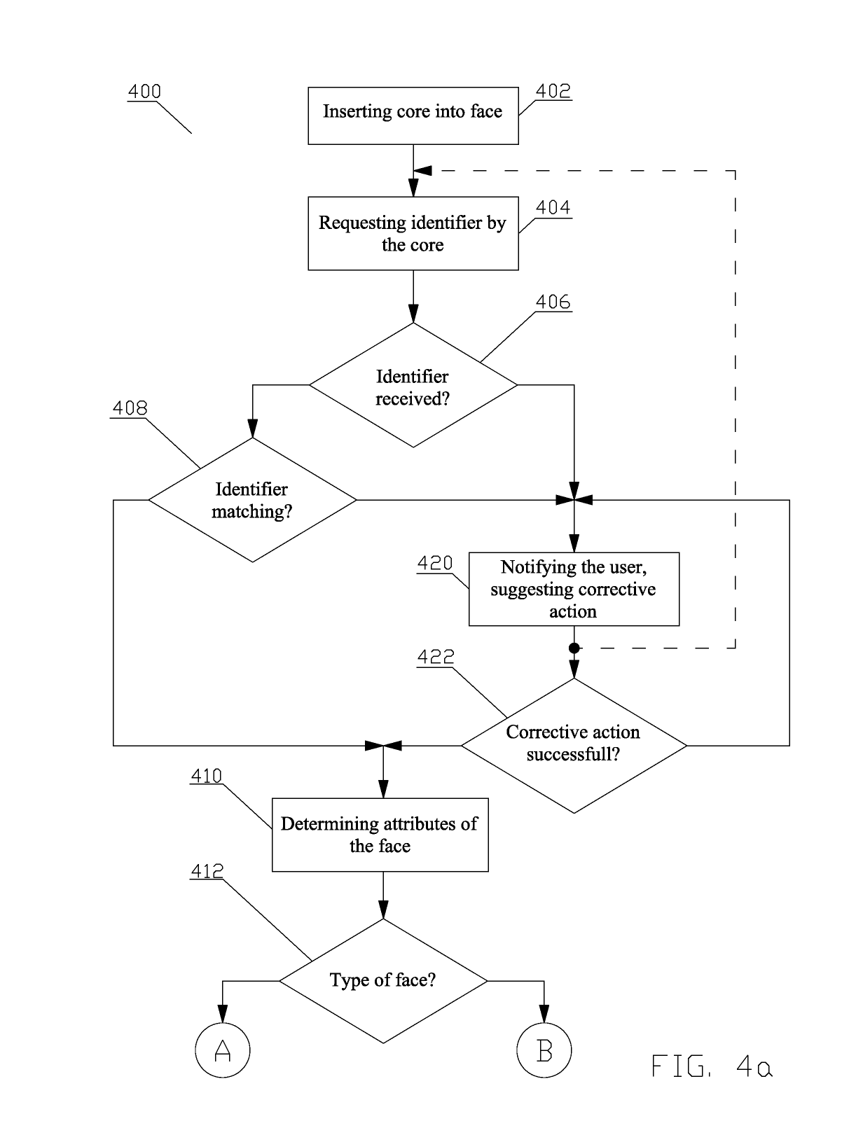

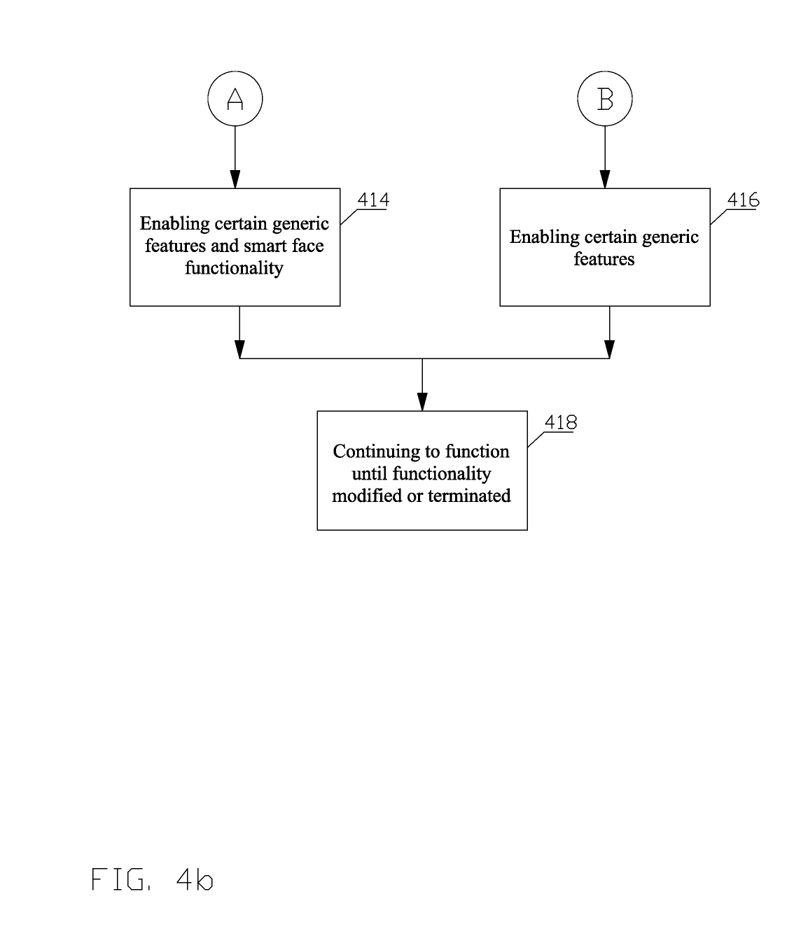

FIG. 4 depicts a flow chart 400 of the process for initiating smart jewelry functionality of FIG. 3 in accordance with aspects of this disclosure. A person of ordinary skill in the art will appreciate that the aspects disclosed in the flow chart 400 are provided to enable a person having ordinary skill in the art to practice the present invention, and various modifications to these aspects will be readily apparent to such a person. Therefore, the flow chart 400 is not exhaustive because certain steps may be added or be unnecessary and/or may be carried out in parallel based on a particular implementation.

In block 402, the core (102) is inserted into the recess (104(6)) of the face (104), thus establishing a communicative coupling of the first electronic component (102(2)) with the second electronic component (104(4)) via the interface (106). The communicative coupling utilizes a basic protocol implementing an essential set of features, i.e., features implemented regardless of a version of the protocol. The protocol may change to support more or different features for both the core (102) and/or the face (104) being developed. However, because at this stage of the process the core (102) is not aware of the attributes of the face, the basic protocol is used. The establishment of the communicative coupling enables the core (102) to detect presence of the second electronic component (104(4)) at the interface port (102(4)). Such detection can comprise polling of the interface port (102(4)), presence of signal at the interface port (102(4)), or any other detection method known to a person of ordinary skill in the art. The process continues in block 404.

In block 404, the core (102) requests an identifier from the second electronic component (104(4)) of the face (104). The process continues in block 406.

In block 406, the core (102) determines whether the second electronic component (104(4)) responded with an identifier. When an identifier is received, the process continues in block 408; otherwise, the process continues in block 420.

In block 408, the core (102) examines the identifier to determine whether the received identifier can be recognized by the core (102). In one aspect, the recognition comprises parsing the received identifier to build a data structure and compare the built data structure with an expected data structure. In another aspect, identifier(s) recognizable by the core (102) may be pre-programmed to the core's (102) memory (not shown) or requested by the core (102) from an external storage, e.g., an Internet cloud, and matched with the received identifier. Other aspects of recognition are known to a person of ordinary skill in the art. Regardless of the manner of recognition, when the received identifier is recognized, the process continues in block 410; otherwise, the process continues in block 420.

In block 410, the core (102) examines the identifier to determine attributes of the face (104) comprising the second electronic component (104(4)). Such attributes may comprise, e.g., a class of face, i.e., a plain face or a smart face; specific features implemented, e.g., display, sensors; and miscellaneous information, e.g., identity of the specific face, version of communication protocol supported by the face (104), and the like. The process continues in block 412.

In block 412, when the core (102) has determined that face (104) is a smart face, the process continues in block 414; otherwise, when the core (102) has determined that face (104) is a plain face, the process continues in block 416.

In block 414, the core (102) activates functionality of the smart face, by, e.g., establishing communication with the smart face (104) using the protocol version supported by both the core (102) and the face (104), activating specific features of the smart face (104), establishing power management, and other features of the smart face. The process continues in block 418.

In block 416, although the plain face does not have any specific features, the core (102) may activate certain generic features not activated before detecting the face, e.g., security features for communication with the host device, measure statistic parameters, (e.g., length of usage), personalize the experience of the application in the host device (e.g., show images of the activated face, suggest purchase of a similar face, adjust graphics and sound profile of the host device application according to the identity of the face), and the like. The process continues in block 418.

In block 418, the jewelry continues to function until the core (102) is removed, or the functionality of the core (102) and the face (104) is modified or terminated otherwise. Such a functionality modification or termination may comprise, e.g., entry by the core to an energy-saving mode, in which at least some features of the face are disabled, exhaustion of the power source(s). The functionality modification or termination may be triggered autonomously, or by user intervention.

In block 420, upon failure to receive or recognize the identifier, in one aspect, the core (102) may return to block 404 (shown as broken line). In another aspect, the user is notified, e.g., through a message provided to the host device, that unknown device has been connected to the core (102) either immediately, or after several loops through block 404. The message may inform the user about the action to be taken, e.g., that the firmware or software of the core (102) is out of date and needs to be updated, that certain troubleshooting steps are to be carried out. The process continues in block 422.

In block 422, the core (102) determines whether the corrective action has been successful. When the determination is positive, the process continues in block 410; otherwise, the process continues in block 420.

The various aspects of this disclosure are provided to enable a person having ordinary skill in the art to practice the present invention. Various modifications to these aspects will be readily apparent to persons of ordinary skill in the art, and the concepts disclosed therein may be applied to other aspects without departing from the spirit or scope of the invention. Thus, the present invention is not intended to be limited to the aspects shown herein but is to be accorded the widest scope consistent with the principles and novel features disclosed herein.

Therefore, by means of an example a person having ordinary skill in the art will understand, that the flow chart is not exhaustive because certain steps may be added or be unnecessary and/or may be carried out in parallel based on a particular implementation. By means of an example, although the identifier from the second electronic component (104(4)) of the face (104) has been described in a primary role additional use may comprise, e.g., authentication, where upon failure to receive or to recognize the identifier, the core (102) disables, either autonomously or interactively with the user at least some generic functions, reports the failure via the host device, or takes any other action in accordance with design criteria. Additionally, or alternatively, the core (102) may report the identifier to the manufacturer for fraud protection, marketing, or other use. By means of another example, the power source may be in the face (104) only, instead of the core (102).

All structural and functional equivalents to the various illustrative logical blocks, modules, circuits, and algorithm steps described in connection with the various aspects described throughout this disclosure that are known or later come to be known to those of ordinary skill in the art are expressly incorporated herein by reference and are intended to be encompassed by the claims. Such illustrative logical blocks, modules, circuits, and algorithm steps may be implemented as electronic hardware, computer software, or combinations of both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A smart jewelry, comprising:
a core comprising a first electronic component and a power source; and
a face comprising a recess adapted to accept the core and a second electronic component.

2. The smart jewelry as claimed in claim 1, wherein the face comprises a decorative item for personal adornment.

3. The smart jewelry as claimed in claim 1, wherein the core and the recess have standardized dimensions.

4. The smart jewelry as claimed in claim 1, wherein upon the core being accepted by the recess of the face, the first electronic component and the second electronic are communicatively coupled via an interface.

5. The smart jewelry as claimed in claim 4, wherein the interface comprises at least:
a bidirectional line for data transfer; and
a reference line for the bidirectional line.

6. The smart jewelry as claimed in claim 5 further comprising:
a rectifier; and
a source of power communicatively coupled to the rectifier.

7. The smart jewelry as claimed in claim 4, wherein the interface comprises
at least one unidirectional or bidirectional line for data transfer;
at least one line for power transfer in both directions; and
at least one reference line for the power transfer line.

8. The smart jewelry as claimed in claim 1, wherein the first electronic component implements generic features of the smart jewelry.

9. The smart jewelry as claimed in claim 1, wherein the second electronic component implements at least storage and communication of identifier of the face.

10. The smart jewelry as claimed in claim 9, wherein the second electronic component further implements specific features of the smart jewelry.

11. The smart jewelry as claimed in claim 1, wherein the face further comprises a source of power.

12. The smart jewelry as claimed in claim 1, wherein the source of power comprises a solar panel.

13. The smart jewelry as claimed in claim 1, wherein the source of power comprises an energy harvesting technology.

14. A method for initiating smart jewelry functionality, comprising:
inserting a core into a recess in a face to establish a communication coupling between a first electronic component of the core and a second electronic component of the face; and
initiating smart jewelry functionality in accordance with information exchanged between the first electronic component and the second electronic component.

15. The method as claimed in claim 14, wherein the initiating smart jewelry functionality in accordance with information exchanged between the first electronic component and the second electronic component comprises:
requesting by the core a face identifier;
determining attributes of the face in accordance with the received identifier; and
initiating smart jewelry functionality in accordance with the determined attributes.

16. The method as claimed in claim 15, wherein the determining attributes of the face in accordance with the received identifier comprises at least:
determining whether a face is a plain face or a smart face.

17. The method as claimed in claim 15, wherein the initiating smart jewelry functionality in accordance with the determined attributes comprises:
enabling certain generic features of the core when the face is determined to be a plain face.

18. The method as claimed in claim 16, wherein the initiating smart jewelry functionality in accordance with the determined attributes comprises:
activating functionality of the face when the face is determined to be a smart face.

19. The method as claimed in claim 15, further comprising:
requesting the face identifier using a first communication protocol; and
utilizing a second communication protocol when the face is determined to be a smart face.
